(19) United States
(12) Patent Application Publication
(10) Pub. No.: US 2010/0058262 A1
(43) Pub. Date: Mar. 4, 2010

(54) VERIFICATION ASSISTING PROGRAM, VERIFICATION ASSISTING APPARATUS, AND VERIFICATION ASSISTING METHOD

(75) Inventors: Rafael Kazumiti MORIZAWA, Kawasaki (JP); Ryosuke OISHI, Kawasaki (JP); Akio MATSUDA, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/472,995

(22) Filed: May 27, 2009

(30) Foreign Application Priority Data
Aug. 27, 2008 (JP) 2008-218411

(51) Int. Cl. G06F 17/50

(52) U.S. Cl. 716/5

(57) ABSTRACT

A verification assisting apparatus for assisting a matching check between a specification and implementation of an object includes: an obtaining unit that obtains a specification description including elements executed to realize functions of the object and restricting conditions of the elements to realize the functions, and an implementation description concerning the functions; a creating unit that creates a graph structure including, as nodes, the elements and the restricting conditions, based on the implementation description; a first correlating unit that correlates nodes in the graph structure with the implementation description; a second correlating unit that correlates a node in the graph structure with the specification description, by detecting the node in the structure using a description concerning the element or the restricting condition in the specification description; and an outputting unit that outputs the correlation results.

### CROSS REFERENCE TO RELATED APPLICATIONS

This application is based upon and claims the benefit of priority of the prior Japanese Patent Application No. 2008-218411, filed on Aug. 27, 2008, the entire contents of which are incorporated herein by reference.

### FIELD

The embodiment(s) discussed herein is (are) related to assertion-based verification of an object to be verified.

### BACKGROUND

In developing hardware or software systems, each of the systems has recently become larger and more complicated due to the advancement of the design technology. On the other hand, due to the shift to larger and complicated systems, the percentage accounted for by the verification step in all the steps for the development tends to increase. In the verification step, verification as to whether the system operates according to the specification thereof is executed.

To verify functions of a system, it is necessary to verify collectively the functions of the system described in the specification. Therefore, a scenario needs to be extracted from the specification as a series of meaningful operations to verify the functions of the system. Conventionally, a technique of converting the content described in the specification described in a natural language into the content described in a language that may be processed by a computer and systematically creating the scenario is present.

Assertion-based verification of verifying the functions of the system using assertions is present. An “assertion” is a restrictive condition to be observed for the functions of the system to correctly operate, and is a text described in the implementation to verify the operations that are intended in designing. The assertion is manually produced in the form of a translation of the specification described in the natural language, using an assertion describing language. However, due to the recent shift to larger systems, the number of assertions necessary becomes tremendous and the work load on the workers has increased. Therefore, techniques of automatically creating assertions from a specification according to an assertion describing language are conventionally present (see, e.g., Japanese Patent Application Laid-Open Publication Nos. 2007-257291 and 2007-11467).

However, according to the above conventional techniques, the relation between the specification of the system and the assertions is not established and, therefore, the tremendous number of assertions dispersed in the implementation need to be manually checked and changed one by one every time the specification of the system is changed. However, the load of this work on the workers is heavy because it is necessary to fully understand the assertion describing language and the characteristics and the functions of the system and, thereby, clearly describe the operations and show in detail the conditions on which the operations are generated.

Therefore, to check and change one by one the assertions dispersed in the implementation need a tremendous number of process steps and, therefore, a problem has arisen that the working time and the work load that are necessary for the verification work are increased. Furthermore, incomplete checks and incomplete changes are highly likely to occur because the work is manually executed and, therefore, a problem has arisen that the verification quality is degraded.

Especially, when the engineers who first created the assertions and the engineers who change the assertions after the change of the specification are different, it is very difficult to identify which one of the assertions dispersed in the implementation is associated with which one of the operations and, therefore, a problem has arisen that the working time and the work load necessary for the verification work are further increased.

### SUMMARY

It is an object in one aspect of the embodiments to at least solve the above problems in the conventional technologies.

According to an aspect of an embodiment, a computer-readable recording medium storing a program for assisting a matching check between a specification and implementation of an object to be verified causes a computer to perform: obtaining a specification description that includes a series of elements executed to realize functions of the object to be verified and restricting conditions of the elements to be satisfied to realize the functions, and an implementation description concerning the functions of the object to be verified; creating a graph structure that includes, as nodes, the series of elements and the restricting conditions on the elements, based on the implementation description; first correlating nodes in the graph structure with description portions in the implementation description concerning the elements or the restricting conditions that the nodes represent; second correlating a node in the graph structure with a description portion in the specification description concerning an element or a restricting condition that the node represents, by detecting the node that represents the element or the restricting condition in the structure using a description concerning the element or the restricting condition in the specification description; and outputting the correlation results correlated at the first and the second correlating.

According to an aspect of an embodiment, a verification assisting apparatus for assisting a matching check between a specification and implementation of an object to be verified includes: an obtaining unit configured to obtain a specification description that includes a series of elements executed to realize functions of the object to be verified and restricting conditions of the elements to be satisfied to realize the functions, and an implementation description concerning the functions of the object to be verified; a creating unit configured to create a graph structure that includes, as nodes, the series of elements and the restricting conditions on the elements, based on the implementation description; a first correlating unit configured to correlate nodes in the graph structure with description portions in the implementation description concerning the elements or the restricting conditions that the nodes represent; a second correlating unit configured to correlate a node in the graph structure with a description portion in the specification description concerning an element or a restricting condition that the node represents, by detecting the node that represents the element or the restricting condition in the structure using a description concerning the element or the restricting condition in the specification description; and an outputting unit configured to output the correlation results correlated by the first and the second correlating unit.

According to an aspect of an embodiment, a verification assisting method for assisting a matching check between a specification and implementation of an object to be verified includes: obtaining a specification description that includes a series of elements executed to realize functions of the object to be verified and restricting conditions of the elements to be satisfied to realize the functions, and an implementation description concerning the functions of the object to be verified; creating a graph structure that includes, as nodes, the series of elements and the restricting conditions on the elements, based on the implementation description; first correlating nodes in the graph structure with description portions in the implementation description concerning the elements or the restricting conditions that the nodes represent; second correlating a node in the graph structure with a description portion in the specification description concerning an element or a restricting condition that the node represents, by detecting the node that represents the element or the restricting condition in the structure using a description concerning the element or the restricting condition in the specification description; and outputting the correlation results correlated by the first and the second correlating.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram of an overview of embodiments;

FIG. 2 is a block diagram of a hardware structure of a verification assisting apparatus;

FIG. 3 is an explanatory diagram of a modeled data structure of a specification description;

FIG. 4 is an explanatory diagram of an exemplary specification description;

FIG. 5 is an explanatory diagram of an exemplary implementation description;

FIG. 6 is a block diagram of a functional configuration of a verification assisting apparatus;

FIG. 7 is an explanatory diagram of an exemplary control flow graph;

FIG. 8 is an explanatory diagram of a link relation between the control flow graph and the implementation description;

FIG. 9 is an explanatory diagram of a data structure of the control flow graph;

FIG. 10 is an explanatory diagram of a link relation between the control flow graph and the specification description;

FIG. 11 is an explanatory diagram of a data structure of the control flow graph;

FIG. 12 is an explanatory diagram of an exemplary specification description;

FIG. 13 is a diagram of a flow of extracting description portions that are influenced by change of a specification;

FIG. 14 is an explanatory diagram of a specific example of an influenced range description;

FIG. 15 is a diagram of a flow of searching for description portions to be changed in an implementation description;

FIG. 16 is an explanatory diagram of an example of report information;

FIG. 17 is a flowchart of an exemplary verification assisting process;

FIG. 18 is a flowchart of an exemplary procedure of a first correlating process;

FIG. 19 is a flowchart of an exemplary procedure of a second correlating process;

FIG. 20 is a flowchart of an exemplary procedure of an extracting process; and

FIG. 21 is a flowchart of an exemplary procedure of a searching process.

### DESCRIPTION OF EMBODIMENT(s)

Preferred embodiments of the present invention will be explained with reference to the accompanying drawings.

In the embodiments, an approach is proposed of efficiently and collectively searching for assertion descriptions in an implementation description to be changed along with a change of the specification by correlating the implementation description with a specification description through a control flow graph which is based on the implementation description of the object to be verified.

In the embodiment, an approach is proposed of assisting a check of matching between the specification and the implementation associated with a change of the specification of a semi-conductor integrated circuit (for example, an LSI: Large Scale Integration) that is an object to be verified. Especially, an approach is proposed of efficiently and collectively identifying the assertion descriptions in the implementation description to be changed along with the change of the specification, noting the assertions that are utilized for the function verification.

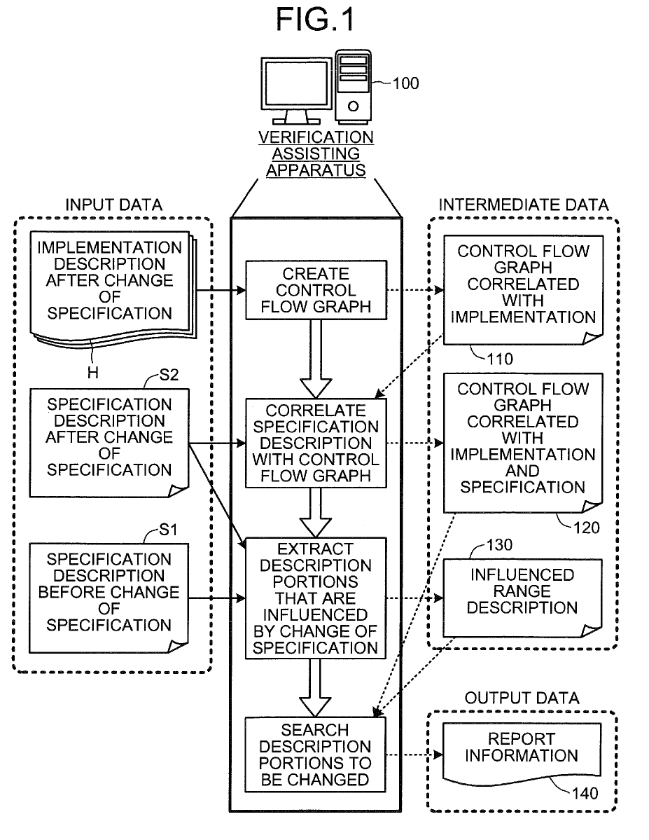

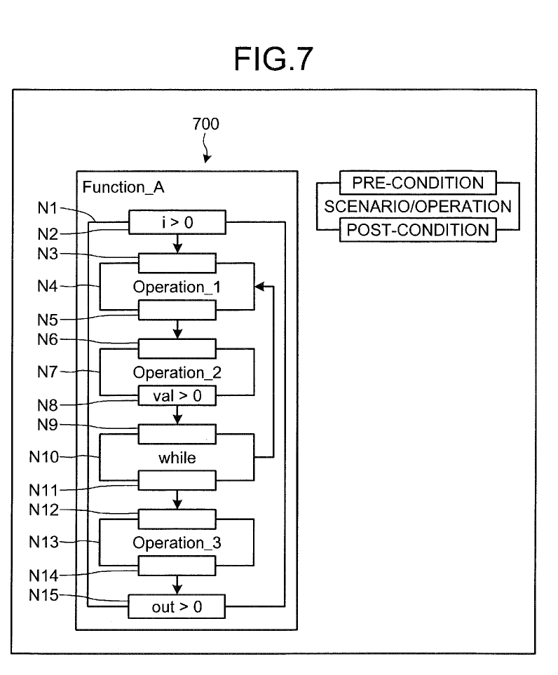

FIG. 1 is an explanatory diagram of an overview of the embodiment. In FIG. 1, a verification assisting apparatus 100 creates a control flow graph that represents the flow of a control executed when an object to be verified is implemented, based on an implementation description H concerning functions obtained after the change of the specification of the object to be verified that is provided as input data. As a result, a control flow graph 110 correlated with the implementation description H (see FIG. 7 below for details) is created.

A specification description S2 obtained after the change of the specification of the object to be verified that is provided as the input data is correlated with the control flow graph 110. As a result, a control flow graph 120 that is correlated with the implementation description H and the specification description S2, and the specification description S2 that is correlated with the control flow graph 120 are created.

Thereafter, by obtaining the difference between a specification description S1 before the change of the specification and the specification description S2 after the change of the specification (the specification description S2 correlated with the control flow graph 120), description portions to be influenced by the change of the specification of the object to be verified are extracted from the specification description S2. As a result, an influenced range description 130 that is a set of the description portions to be influenced by the specification change is created.

The description portions in the implementation description H to be changed due to the change of the specification of the object to be verified are searched for by tracing a bilateral link between the pieces of data using the implementation description H, the influenced range description 130, and the control flow graph 120 after the change of the specification, and finally, the search result is output as report information 140.

A verifying person may grasp the description portions in the implementation description H to be changed due to the change of the specification of the object to be verified by checking the report information 140. Especially, the assertion descriptions to be changed associated with the change of the specification may be collectively grasped from the tremendous number (for example, several thousand to several hundred thousand) of assertion descriptions dispersed in the implementation description H.

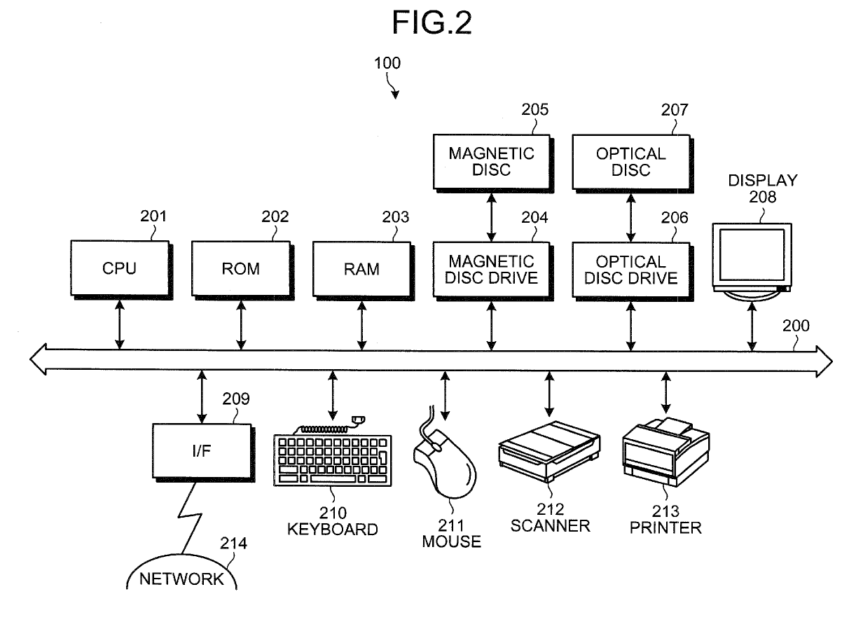

A hardware structure of the verification assisting apparatus 100 is explained. FIG. 2 is a block diagram of a hardware structure of the verification assisting apparatus. In FIG. 2, the verification assisting apparatus 100 includes a central processing unit (CPU) 201, a read-only memory (ROM) 202, a random access memory (RAM) 203, a magnetic disk drive 204, a magnetic disk 205, an optical disc drive 206, an optical disc 207, a display 208, an interface (I/F) 209, a keyboard 210, a mouse 211, a scanner 212, and a printer 213, respectively connected by a bus 200.

The CPU 201 governs overall control of the verification assisting apparatus 100. The ROM 202 stores therein programs such as a boot program. The RAM 203 is used as a work area of the CPU 201. The magnetic disk drive 204, under the control of the CPU 201, controls the reading and writing of the data with respect to the magnetic disk 205. The magnetic disk 205 stores therein the data written under control of the magnetic disk drive 204.

The optical disc drive 206, under the control of the CPU 201, controls the reading and writing of data with respect to the optical disc 207. The optical disc 207 stores therein the data written under control of the optical disc drive 206, the data being read by a computer.

The display 208 displays, for example, data such as text, image, functional information, etc., in addition to a cursor, icons, and/or tool boxes. A cathode ray tube (CRT), a thin-film-transistor (TFT) liquid crystal display, a plasma display, etc., may be employed as the display 308.

The I/F 209 is connected to a network 214 such as a local area network (LAN), a wide area network (WAN), and the Internet through a communication line and is connected to other apparatuses through the network 214. The I/F 209 administers an internal interface with the network 214 and controls the input/output of data from/to external apparatuses. For example, a modem or a LAN adaptor may be employed as the I/F 209.

The keyboard 210 includes, for example, keys for inputting letters, numerals, and various instructions and performs the input of data. Alternatively, a touch-panel-type input pad or numeric keypad, etc. may be adopted. The mouse 211 is used to move the cursor, select a region, or move and change the size of windows. A track ball or a joy stick may be adopted provided each respectively has a function similar to a pointing device.

The scanner 212 optically reads an image and takes in the image data into the verification assisting apparatus 100. The scanner 212 may have an optical character recognition (OCR) function as well. The printer 213 prints image data and text data. The printer 213 may be, for example, a laser printer or an ink jet printer.

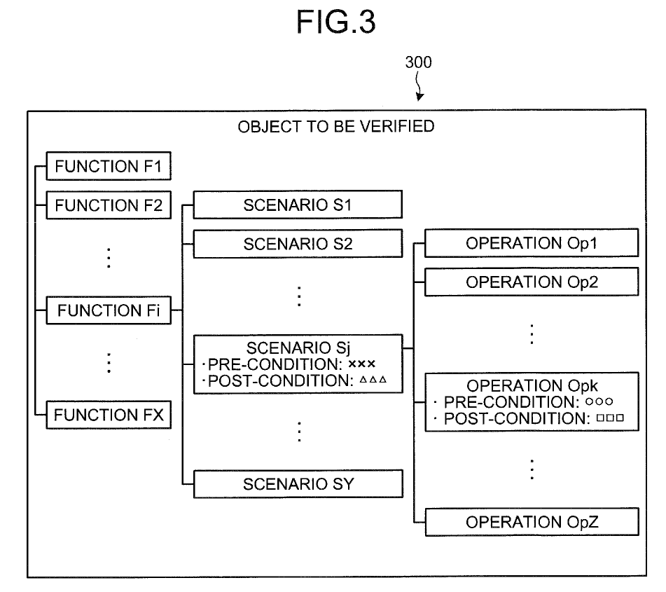

A data structure of the specification description of the object to be verified (for example, the specification descriptions S1 and S2) will be described. FIG. 3 is an explanatory diagram of a modeled data structure of the specification description. As depicted in FIG. 3, a specification model 300 has a hierarchy structure including a group of functions, a group of scenarios, and a group of operations concerning the object to be verified.

More specifically, the specification model 300 includes functions F1 to FX. A function F1 (i=1, 2, . . . , X) includes scenarios S1 to SY. A scenario Sj (j=1, 2, . . . , Y) includes operations Op1 to OpZ. For the scenario Sj and the operation Opk, a pre-condition and a post-condition are defined. The functions, the scenarios, the operations, the pre-conditions, and the post-conditions will be described later in detail.

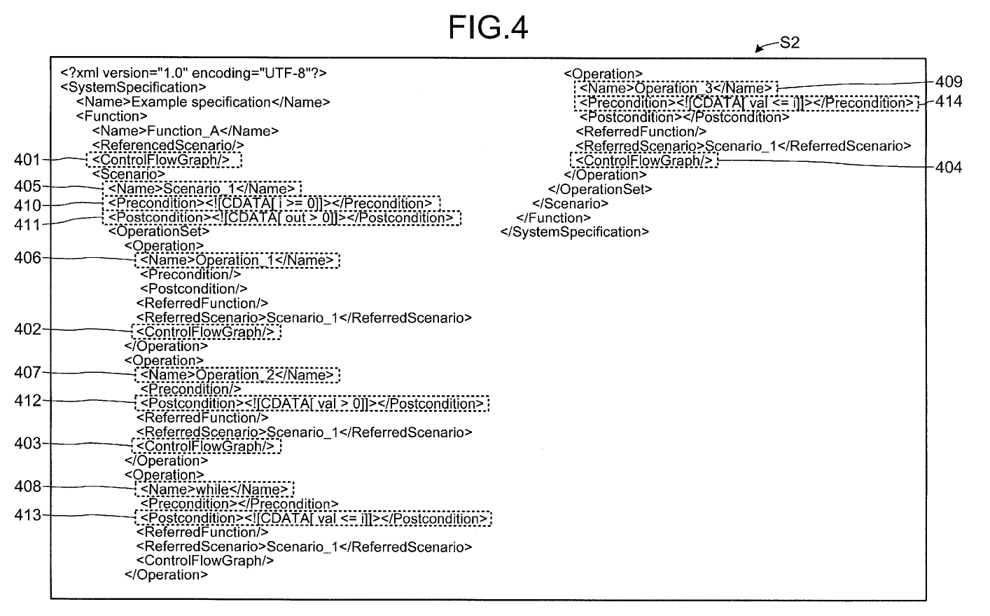

FIG. 4 is an explanatory diagram of a specific exemplary specification description (Part 1). In FIG. 4, the functional specification of the object to be verified is described using an Extensible Markup Language (XML) in the specification description S2. In FIG. 4, a portion of the specification description S2 is extracted and shown.

More specifically, a scenario “Scenario_1” that defines a series of operations executed to realize a function “Function_A”, and the series of operations “Operation_1”, “Operation_2”, “While”, and “Operation_3” are described in the specification description S2.

A character string sandwiched by <Precondition> and </Precondition> expresses a pre-condition concerning the scenario or the operation described immediately therebefore. A character string sandwiched by <Postcondition> and </Postcondition> expresses a post-condition concerning the scenario or the operation described immediately therebefore.

In the embodiments, each of pre-conditions or post-conditions that are defined in scenarios and operations is handled as an assertion. An assertion is a restrictive condition to be observed for the functions of the object to be verified to correctly operate, and is described in the implementation to verify the operations that are intended in the design. By describing an assertion in the above format, a computer may recognize an assertion description in the specification description. Only the pre-conditions and the post-conditions are handled as assertions in the embodiments and, therefore, other factors (such as, for example, an invariant condition) are omitted.

In the specification description S2, link items 401 to 404 are described that identify insertion positions of link information that correlates each of nodes in the control flow graph that is created using the implementation description H of the object to be verified, with the description in the specification description S2. For example, the link item 401 is an insertion position of the link information that correlates the function “Function_A” in the specification description S2 with the control flow graph.

The link item 402 is an insertion position of link information that correlates the operation “Operation_1” in the specification description S2 with a node representing the operation “Operation_1” in the control flow graph. In FIG. 4, numerals 405 to 414 will be used in the description later.

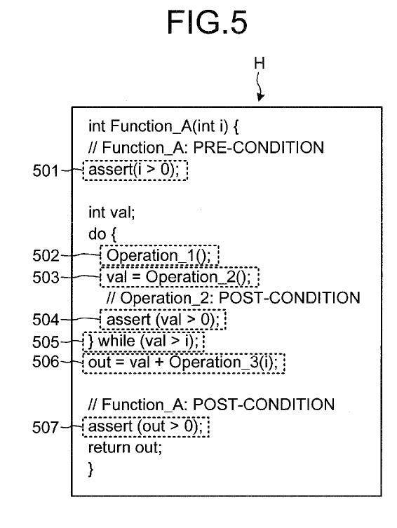

FIG. 5 is an explanatory diagram of an exemplary implementation description. In FIG. 5, in the implementation description H, a program to realize the function “Function_A” of the object to be verified is described using an HDL (Hardware Description Language).

More specifically, “Operation_1”, “Operation_2”, “While”, and “Operation_3” that are the series of operations executed to realize the function “Function_A” are described in the implementation description H. In this case, the scenario that constitutes the function “Function_A” is one and, therefore, the description concerning the name of the scenario is omitted.

In the implementation description H, a line starting with “//” expresses a comment. More specifically, the type of an assertion (the pre-condition or the post-condition) is described as the comment. By utilizing this comment expression, the computer may recognize the assertion description in the implementation description H.

The description concerning the scenario that constitutes the function “Function_A” is omitted in the implementation description H and, therefore, the pre-condition and the post-condition of the scenario are described respectively as a pre-condition and a post-condition of the function “Function_A”. Numerals 501 to 507 will be used in the description later.

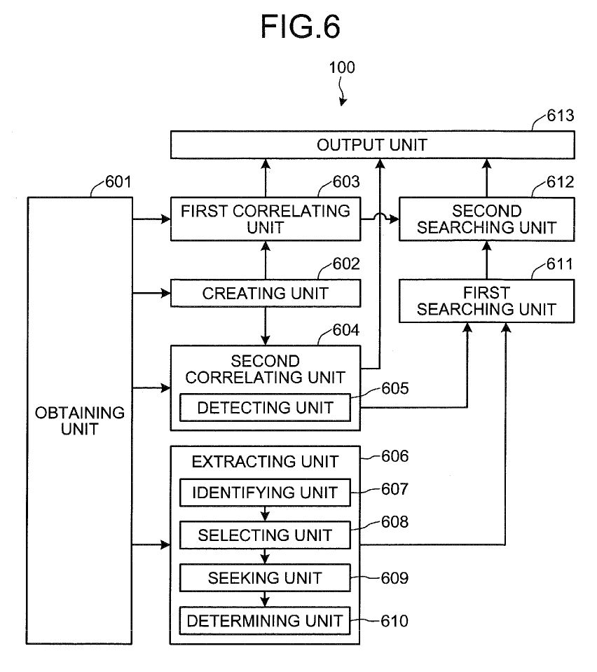

FIG. 6 is a block diagram of the functional configuration of a verification assisting apparatus. In FIG. 6, the verification assisting apparatus 100 includes an obtaining unit 601, a creating unit 602, a first correlating unit 603, a second correlating unit 604, a detecting unit 605, an extracting unit 606, an identifying unit 607, a selecting unit 608, a seeking unit 609, a determining unit 610, a first searching unit 611, a second searching unit 612, and an output unit 613.

More specifically, the functions that are included in a control unit (the obtaining unit 601 to the output unit 613) realize the functions thereof by, for example, causing the CPU 201 to execute a program stored in a storage area such as the ROM 202, the RAM 203, the magnetic disk 205, or the optical disk 207 depicted in FIG. 2, or by the I/F 209.

The obtaining unit 601 has a function of obtaining the specification description that has described therein a series of elements executed to realize the functions of the object to be verified and restricting conditions of the elements to be satisfied to realize the functions, and the implementation description concerning the functions of the object to be verified.

A specification description is an electronic document that has described therein functions, scenarios, operations, parameters, etc., of the object to be verified as specification items (for example, the specification description S2 depicted in FIG. 4). An implementation description is an electronic document that has described therein specifications and algorithms of the object to be verified as programs in a program language (for example, the implementation description H depicted in FIG. 5).

An element is a scenario that is included in a function of the object to be verified, or an operation that is included in a scenario. A scenario defines a series of operations executed to realize a function. An operation is an action obtained by finely decomposing a specification of the object to be verified. For each of a scenario and an operation, a restricting condition is defined as attribute information. A restricting condition can be, for example, a pre-condition, a post-condition, or an invariant condition.

A pre-condition is a condition to be satisfied (to be true) before the execution of the series of operations that realize a function. A post-condition is a condition to be satisfied after the execution of the series of operations. An invariant condition is a condition that is invariant and that is required until a post-condition occurs (during the execution of the series of operations). As above, in the embodiments, each of a pre-condition and a post-condition is handled as an assertion.

The specification descriptions (the specification descriptions S1 and S2) and the implementation description (the implementation description H) may be directly input into the verification assisting apparatus 100. Otherwise, those descriptions may be obtained from an external computer apparatus. The specification descriptions and the implementation description obtained are stored in the storage area such as the RAM 203, the magnetic disk 205, or the optical disc 207.

The creating unit 602 has a function of creating a structure that has a graph of the series of elements and the restricting conditions on the elements represented as nodes, based on the implementation description obtained by the obtaining unit 601. More specifically, for example, the scenario, the operations, the pre-conditions, the post-conditions, and the invariant conditions described in the implementation description may be represented as nodes in a directed graph and, thereby, a control flow graph (CFG) may be created that shows the flow of the control during the implementation of the object to be verified.

Because the control flow graph is created based on the implementation description, a control flow graph is created for each of the functions when an implementation description is prepared for each of the functions. A specific approach of creating a control flow graph is a known technique and, therefore, the description thereof is omitted (see, e.g., Alfred V. Aho, Ravi Sethi, and Jeffrey D. Ullman, “Compilers” pp. 528 to 534, Addison Wesley, 1985).

The control flow graph based on the implementation description H depicted in FIG. 5 will be described. FIG. 7 is an explanatory diagram of a specific exemplary control flow graph. In FIG. 7, a control flow graph 700 is a structure where the flow of the control of the function “Function_A” is graphed. More specifically, the control flow graph 700 represents the scenario, the operations, the pre-conditions, and the post-conditions as nodes N1 to N15 and expresses the flow of the control of the function “Function_A” as directed edges between the nodes.

For example, the node N2 represents a pre-condition “i>0” described in a description portion 501 in the implementation description H. The node N4 represents the operation “Operation_1” described in a description portion 502 in the implementation description H. The node N8 represents a post-condition “val>0” in a description portion 504 in the implementation description H.

The control flow graph 700 has a node structure that includes a node representing a pre-condition or a post-condition that is attached above or under each node that represents a scenario or an operation (see the upper right portion of FIG. 7). Therefore, even when no description portions concerning a scenario, a pre-condition, and a post-condition are present in the implementation description H, nodes representing scenarios, pre-conditions, and post-conditions are expressed.

For example, the node N1 represents the scenario that is included in the function “Function_A”. The node N3 represents that any pre-condition of the operation “Operation_1” is “not present”. The node N5 represents that any post-condition of the operation “Operation_1” is “not present”.

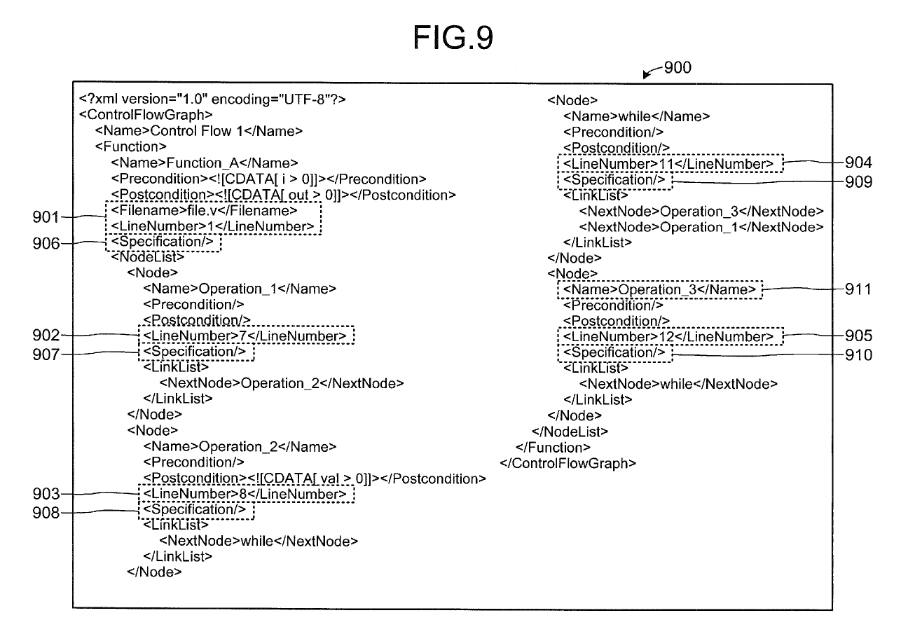

According to such a node structure, the pre-condition and the post-condition of each scenario or each operation may be automatically recognized by a computer by identifying a node that represents each scenario or each operation and identifying nodes to be attached above or under the node that represents the scenario or the operation. Though the detail of the above will be described with reference to FIG. 9, the entity of the control flow graph 700 is electronic information described using the XML, etc. The structure created (for example, the control flow graph 700) is stored in the storage area such as the RAM 203, the magnetic disk 205, or the optical disc 207.

Returning to the description of FIG. 6, the first correlating unit 603 has a function of correlating nodes in the structure created by the creating unit 602 with description portions in an implementation description concerning elements or restricting conditions that the nodes represent. More specifically, the correlating unit 603 correlates, for example, the nodes in the control flow graph 700 with the description portions 501 to 507 in the implementation description H that are creation origins of the nodes (in this case, N2, N4, N7, N8, N10, N13, and N15).

More specifically, for example, when the implementation description H is read, the line number of each description portion may be identified and link information that correlates the line number of the description portion that is the creation origin of each node with a node may be created. In this case, the first correlation result by the first correlating unit 603 is link information that indicates the link relation between the nodes N2, N4, N7, N8, N10, N13, and N15 and the description portions 501 to 507. This link information is, for example, converted into a list and is stored in the storage area such as the RAM 203, the magnetic disk 205, or the optical disc 207. The link information may be directly inserted into the control flow graph 700.

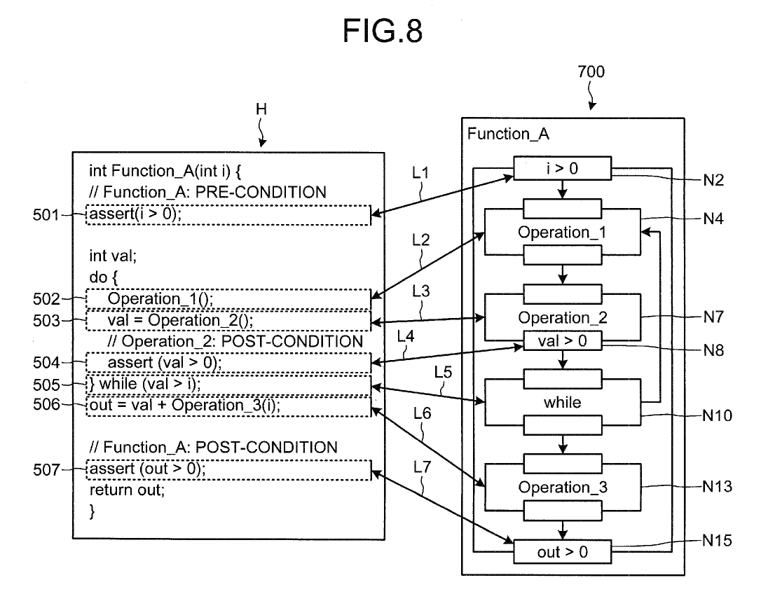

The link relation between the control flow graph 700 and the implementation description H will be described. FIG. 8 is an explanatory diagram of the link relation between the control flow graph and the implementation description. In FIG. 8, links L1 to L7 represent the link relation between the nodes N2, N4, N7, N8, N10, N13, and N15 in the control flow graph 700 and the description portions 501 to 507 in the implementation description H.

Taking the link L1 as an example, an explanation is given. The node N2 is created based on the description portion 501 in the implementation description H and, therefore, the node N2 has a link relation with the description portion 501 that is the creation origin. These links L1 to L7 are inserted in the control flow graph 700 as link information (for example, line numbers in the implementation description H).

The data structure of the control flow graph 700 inserted with the link information will be described. FIG. 9 is an explanatory diagram of the data structure of the control flow graph (Part 1). In a CFG description 900 of FIG. 9, the flow of the control of the function “Function_A” shown in the control flow graph 700 is described using the XML.

In the CFG description 900, pieces of link information 901 to 905 are inserted that indicate the links L1 to L7 between the node N2, N4, N7, N8, N10, N13, and N15 in the control flow graph 700 and the description portions 501 to 507 in the implementation description H. The pieces of link information 901 to 905 indicate link relations of a portion of the links L1 to L7.

The link information 901 includes the file name “file.v” of the implementation description H, the creation origin of the control flow graph 700, and the line number “1” in the implementation description H at which the function “Function_A” is described. The link information 901 is information that indicates the correlation between the control flow graph 700 and the implementation description H and that corresponds to none of the links L1 to L7.

The link information 902 includes the line number “7” in the implementation description H at which the operation “Operation_1” is described. The link information 902 corresponds to the link L2. The link information 903 includes the line number “8” in the implementation description H at which the operation “Operation_2” is described. The link information 903 corresponds to the link L3.

The link information 904 includes the line number “11” in the implementation description H at which the operation “While” is described. The link information 904 corresponds to the link L5. The link information 905 includes the line number “12” in the implementation description H at which the operation “Operation_3” is described. The link information 905 corresponds to the link L6.

According to the pieces of link information 901 to 905, the description portions 502, 503, 505, and 506 in the implementation description H that are respectively correlated with the node N4, N7, N10, and N13 can be identified. As above, pieces of link information concerning the nodes N2, N8, and N15 (the links L1, L4, and L7) that represent the pre-conditions and the post-conditions are not inserted into the CFG description 900.

This is because, when a description portion in the implementation description H can be identified from the link information of a node that indicates a scenario or an operation, a location of the post-conditions or the pre-conditions of the scenario or the operation can be identified by referring to the comment representation (the details of this will be described later). The CFG description 900 has described therein the link items 906 to 910 that specify insertion positions of the pieces of link information that correlate the node N1 to N15 in the control flow graph 700 with descriptions in the specification description S2.

For example, the link item 906 is the insertion position of the link information that correlates the control flow graph 700 with the function “Function_A” in the specification description S2. The link item 907 is the insertion position of the link information that correlates the node N2 in the control flow graph 700 with the operation “Operation_1” in the specification description S2.

Returning to the description of FIG. 6, the second correlating unit 604 has a function of correlating a node in the structure with a description portion in the specification description concerning an element or a restricting condition that the node represents, by detecting the node that represents the element or the restricting condition in the structure using a description concerning the element or the restricting condition in the specification description.

The specific content of a correlating process by the second correlating unit 604 will be described taking as an example the specification description S2 depicted in FIG. 4 and the CFG description 900 (the control flow graph 700) depicted in FIG. 9. The detecting unit 605 detects a description portion concerning an arbitrary scenario from the specification description S2 using the name of the scenario as a clue. In this case, a description portion 405 is detected.

The detecting unit 605 detects from the CFG description 900 a node representing the scenario “Scenario_1” using the name of the scenario of the description portion 405 as a clue. In this case, the node is not detected because the implementation description H that is the creation origin of the control flow graph 700 does not include any description concerning the scenario “Scenario_1”.

The detecting unit 605 detects a description portion concerning an operation that is included in the scenario “Scenario_1” from the specification description S2 using the name of the operation as a clue. In this case, description portions 406 to 409 are sequentially detected. The detecting unit 605 also detects from the CFG description 900 the nodes representing the operations “Operation_1”, “Operation_2”, “While”, and “Operation_3” using the names of the operations in the description portions 406 to 409 as clues. In this case, the nodes N4, N7, N10, and N13 (see FIG. 7) are sequentially detected.

After this, the second correlating unit 604 correlates the detected nodes N4, N7, N10, and N13 respectively with the description portions 406 to 409 in the specification description S2 concerning the operations that represent the nodes N4, N7, N10, and N13. When the node representing the scenario “Scenario_1” is detected from the CFG description 900, these are also correlated.

The detecting unit 605 detects description portions concerning the pre-conditions and the post-conditions of the scenario “Scenario” and the operations “Operation_1”, “Operation_2”, “While”, and “Operation_3” from the specification description S2 using tags representing the pre-conditions and the post-conditions as clues. In this case, description portions 410 to 414 are detected.

After this, nodes representing the pre-conditions and the post-conditions are detected from the CFG description 900 using the nodes representing the scenario and the operations that have been detected as clues. In this case, the nodes N2, N15, N8, N11, and N12 representing the pre-conditions and the post-conditions of the description portions 410 to 414 are detected. Taking the description portion 412 as an example, the node N8 representing the post-condition of operation “Operation_2” attached under the node N7 is detected using the detected node N7 as a clue.

In this manner, nodes representing pre-conditions and post-conditions are detected utilizing the node structure and using nodes representing a scenario and operations as clues. Therefore, mismatching with the pre-conditions and the post-conditions described in the implementation description H (for example, the description portion 410), and pre-conditions and post-conditions that are not described in the implementation description H may be present (for example, description portions 413 and 414).

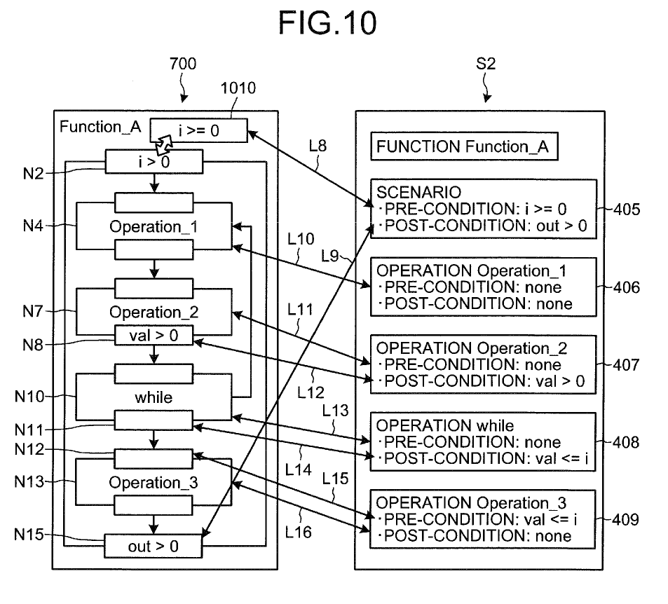

Therefore, as denoted by a numeral 1010 in FIG. 10, which is described later, when a node representing a description portion in the specification description S2 (in this example, a pre-condition “i>=0”) is not present in the control flow graph 700, a new node representing the description portion may be created and inserted into the control flow graph 700.

When the detecting unit 605 does not detect any node from the CFG description 900 using the name of an operation as a clue, an error message expressing that any node representing an operation having the same name is not included may be presented to a user. This reports that mismatching of the names of operations between the specification description S2 and the implementation description H occurs.

The second correlating unit 604 correlates the nodes N2, N15, N8, N11, and N12 with the description portions 410 to 414 in the specification description S2 concerning the pre-conditions and the post-conditions that represent the nodes N2, N15, N8, N11, and N12.

In this case, the second correlation result from the second correlating unit 604 is link information that indicates, for example, the link relation between the nodes N2, N4, N7, N8, N10, N1, N12, N13, and N15 and the description portions 406 to 414. This link information is, for example, converted into a list and stored in the storage area such as the RAM 203, the magnetic disk 205, or the optical disc 207. The link information may be directly inserted into the control flow graph 700.

The link relation between the control flow graph 700 and the specification description S2 will be described. FIG. 10 is an explanatory diagram of the link relation between the control flow graph and the specification description. In FIG. 10, links L8 to L16 represent link relations between the nodes N2, N4, N7, N8, N10, N1, N12, N13, and N15 and description portions 405 to 409 in the specification description S2 (the link relation between the description portion 405 and the node N1 is not shown).

The links L8 to L16 are, for example, inserted into the control flow graph 700 and the specification description S2 as link information. As to the link L8, as above, a node representing the description portion 410 in the specification description S2 is not present in the control flow graph 700 and, therefore, a node representing this description portion is newly created and is inserted into the control flow graph 700 (the numeral 1010).

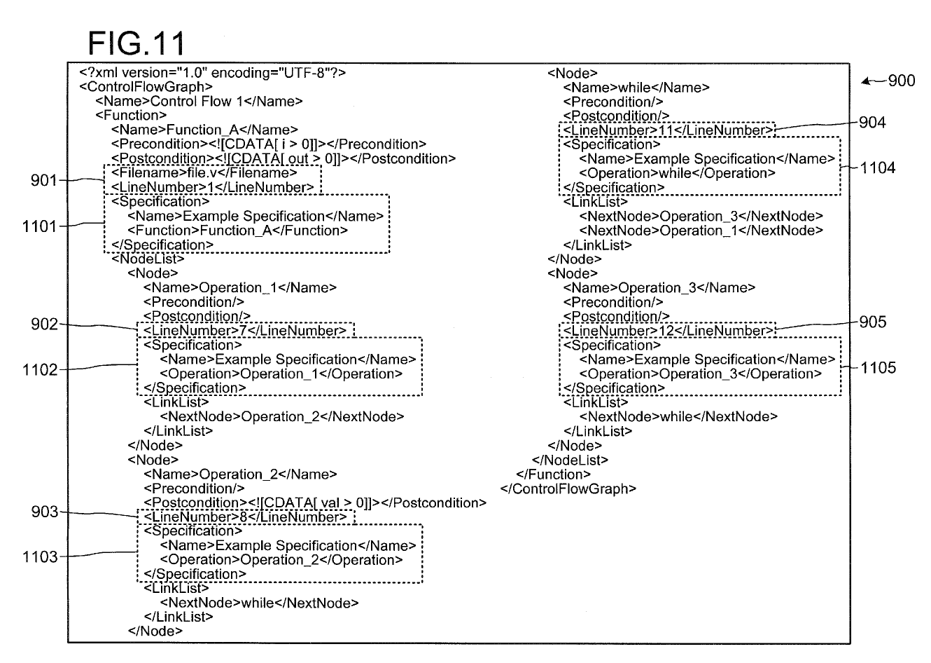

FIG. 11 is an explanatory diagram of the data structure of the control flow graph (Part 2). In FIG. 11, pieces of link information 1101 to 1105 that represent the links L8 to L16 between the nodes N2, N4, N7, N8, N10, N1, N12, N13, and N15 in the control flow graph 700 and the description portions 406 to 409 in the specification description S2 are inserted into the CFG description 900.

The link information 1101 includes the name of the specification document “Example Specification” and the function “Function_A” of the specification description S2. The link information 1101 is information that indicates the correlation between the control flow graph 700 and the specification description S2 and that corresponds to none of the links L8 to L16.

The link information 1102 includes the name of the specification document “Example Specification” and the operation “Operation_1” of the specification description S2. The link information 1102 corresponds to the link L10. The link information 1103 includes the name of the specification document “Example Specification” and the operation “Operation_2” of the specification description S2. The link information 1103 corresponds to the link L11.

The link information 1104 includes the name of the specification document “Example Specification” and the operation “While” of the specification description S2. The link information 1104 corresponds to the link L13. The link information 1105 includes the name of the specification document “Example Specification” and the operation “Operation_3” of the specification description S2. The link information 1105 corresponds to the link L16.

According to the pieces of link information 1101 to 1105, the description portions 406 to 409 in the specification description S2 that are correlated with the nodes N4, N7, N10, and N13 can be identified.

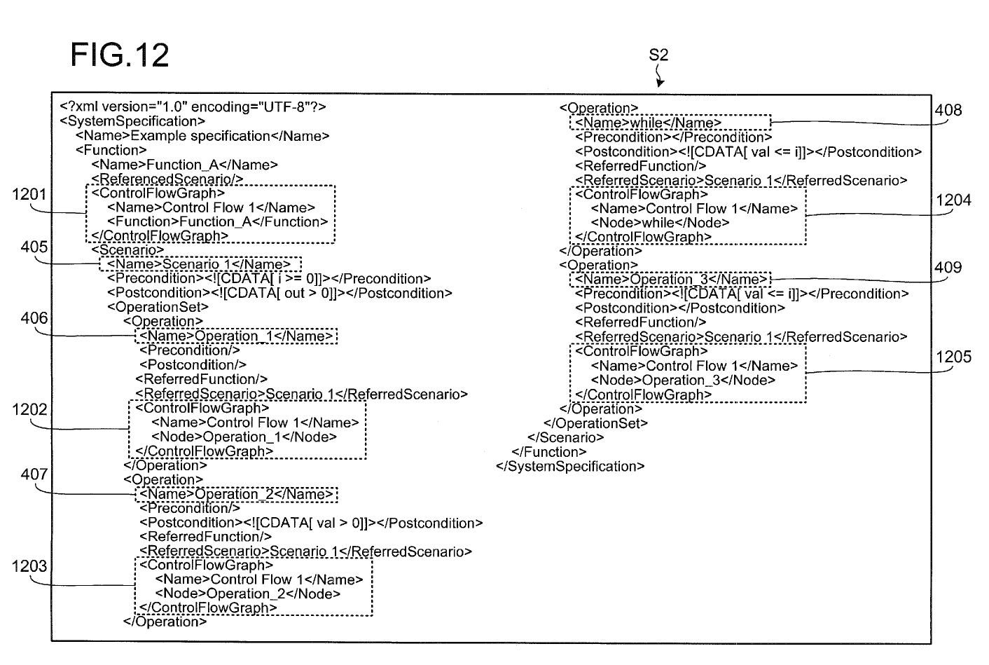

FIG. 12 is an explanatory diagram of a specific example of the specification description (Part 2). In FIG. 12, pieces of link information 1201 to 1205 that represent the links L8 to L16 between the nodes N2, N4, N7, N8, N10, N1, N12, N13, and N15 in the control flow graph 700 and the description portions 406 to 409 in the specification description S2 are inserted into the specification description S2.

The link information 1201 includes the CFG name “ControlFlowGraph” and the function “Function_A” of the control flow graph 700. The link information 1201 is information that indicates the correlation between the control flow graph 700 and the specification description S2 and that corresponds to none of links L8 to L16.

The link information 1202 includes the CFG name “ControlFlowGraph” and the name of a node “Operation_” of the control flow graph 700. The link information 1202 corresponds to the link L10. The link information 1203 includes the CFG name “ControlFlowGraph” and the name of a node “Operation_2” of the control flow graph 700. The link information 1203 corresponds to the link L11.

The link information 1204 includes the CFG name “ControlFlowGraph” and the node name “While” of the control flow graph 700. The link information 1204 corresponds to the link L13. The link information 1205 includes the CFG name “ControlFlowGraph” and the node name “Operation_3” of the control flow graph 700. The link information 1205 corresponds to the link L16.

According to the link information 1201-1205, the nodes N4, N7, N10, and N13 of the control flow graph 700 that are correlated with the description portions 406 to 409 in the specification description S2 can be specified.

Returning to the description of FIG. 6, the output unit 613 has a function of outputting the correlation results correlated by the first correlating unit 603 and the second correlating unit 604. More specifically, the output unit 613 may output the CFG description 900 depicted in FIG. 11 and the specification description S2 depicted in FIG. 12, or may output the link information that is converted into a list.

An output form can be, for example, to display a result on the display 208, to print by outputting to the printer 213, or to transmit to an external apparatus via the I/F 209. The output form can also be to store in the storage area such as the RAM 203, the magnetic disk 205, or the optical disc 207.

According to the first and the second correlation results correlated by the first correlating unit 603 and the second correlating unit 604 (for example, the CFG description 900 depicted in FIG. 11 and the specification description S2 depicted in FIG. 12), the correlations between the description portions concerning the elements and the restricting conditions in the specification description of the changed specification, and the description portions concerning the elements and the restricting conditions in the implementation description concerning the functions after the change of the specification can be recognized.

An approach of checking the matching between the specification and the implementation after the specification of the object to be verified is changed will be described with reference to the above first and second correlation results. The change of the specification of the object to be verified can be a change over the whole object to be verified such as addition, deletion, or a change of the functions of the object to be verified.

More specifically, a change of a function can be addition or deletion of a scenario. A change of a scenario can be addition, deletion, or a change of order of an operation, in addition to a change of a pre-condition, a post-condition, or an invariant condition. A change of an operation can be: a change of a pre-condition, a post-condition, or an invariant condition; addition, deletion, or a change of order of another operation to be invoked; or a change of a parameter setting.

Functions of the functional units for realizing the approach of checking the matching between the specification and the implementation will be described. The extracting unit 606 extracts, from the specification description obtained after the change of the specification, description portions that are influenced by the change of the specification of the object to be verified. More specifically, for example, the description portions that are influenced by the change of the specification may be automatically extracted from the specification description S2 using the specification description S1 before the change of the specification and the specification description S2 after the change of the specification of the object to be verified.

Description portions influenced by the change of the specification may be designated in the specification description S2 by operating the keyboard 210 or the mouse 211 depicted in FIG. 2 by a user. In this case, the extracting unit 606 extracts the designated description portions from the specification description S2. The description portions extracted are stored in the storage area such as the RAM 203, the magnetic disk 205, or the optical disc 207.

The identifying unit 607 identifies the changed portions in the specification description of the changed specification associated with the change of the specification of the object to be verified, using the specification descriptions of the unchanged and changed specification of the object to be verified.

More specifically, the changed portions that are changed due to the change of the specification can be identified by detecting the difference between the specification description S1 and the specification description S2 using, for example, an existing difference detection program (for example, a “diff” command). This difference set is, for example, a set of description portions described in the XML. The changed portions identified are stored in the storage area such as the RAM 203, the magnetic disk 205, or the optical disc 207.

The description portions that are directly and indirectly influenced by the change of the specification (influenced ranges) in the object to be verified are extracted from the specification description S2 based on the changed portions. An exemplary approach of extracting the influenced ranges from the specification description S2 will be described.

The selecting unit 608 selects an arbitrary element from the changed portions identified by the identifying unit 607. More specifically, for example, the selecting unit 608 selects the arbitrary element using the name of the element (such as the name of a scenario or the name of an operation) as a clue. The selection result is stored in the storage area such as the RAM 203, the magnetic disk 205, or the optical disc 207.

The seeking unit 609 seeks for a restricting condition of the selected element from the specification description of the changed specification. More specifically, the seeking unit 609 seeks for a pre-condition and/or a post-condition that serves under the selected element using, for example, tags representing the pre-condition and the post-condition as clues. The search result that has been found is stored in the storage area such as the RAM 203, the magnetic disk 205, or the optical disc 207.

The determining unit 610 determines the description portion concerning the restricting condition found by the seeking unit 609 as a description portion that is influenced by the change of the specification of the object to be verified. The determination result is stored in the storage area such as the RAM 203, the magnetic disk 205, or the optical disc 207.

The seeking unit 609 seeks for elements that are influenced by the change of the specification from the specification description of the changed specification by sequentially tracing elements that are the transition origins, using the element selected by the selecting unit 608 as the starting point, based on the transition relation between elements that is based on the specification description of the changed specification. The transition relation between the elements may be recognized using, for example, a transition graph obtained by forming a directed graph from nodes, the elements described in the specification description after the change of the specification.

More specifically, by referring to the transition graph with an existing seeking algorithm, the elements that are the transition origins are sequentially traced using the element selected by the selecting unit 608 as the starting point and, thereby, the elements that are influenced by the change of the specification can be sought for. For example, when a new operation is added due to the change of the specification, the scenario including this operation and other operations that invoke this operation are sought for. In this case, the determining unit 610 determines the description portions concerning the sought-for elements and the description portions concerning the restricting conditions of the elements as the description portions that are influenced by the change of the specification of the object to be verified.

The selecting unit 608 selects an arbitrary restricting condition from the changed portions. More specifically, the selecting unit 608 selects the restricting conditions using, for example, a tag representing the pre-condition or the post-condition as a clue. In this case, the seeking unit 609 seeks for the element for which the selected restricting condition is defined, from the specification description of the changed specification. The determining unit 610 determines the description portions concerning the sought-for element as the description portion that is influenced by the change of the specification of the object to be verified.

The series of process steps executed by the selecting unit 608, the seeking unit 609, and the determining unit 610 are repeated until, for example, any unselected elements and any unselected restricting conditions that are not selected from the changed portions are not present. The extracting unit finally extracts the changed portions identified by the identifying unit 607 and the description portions determined by the determining unit 610 from the specification description of the changed specification.

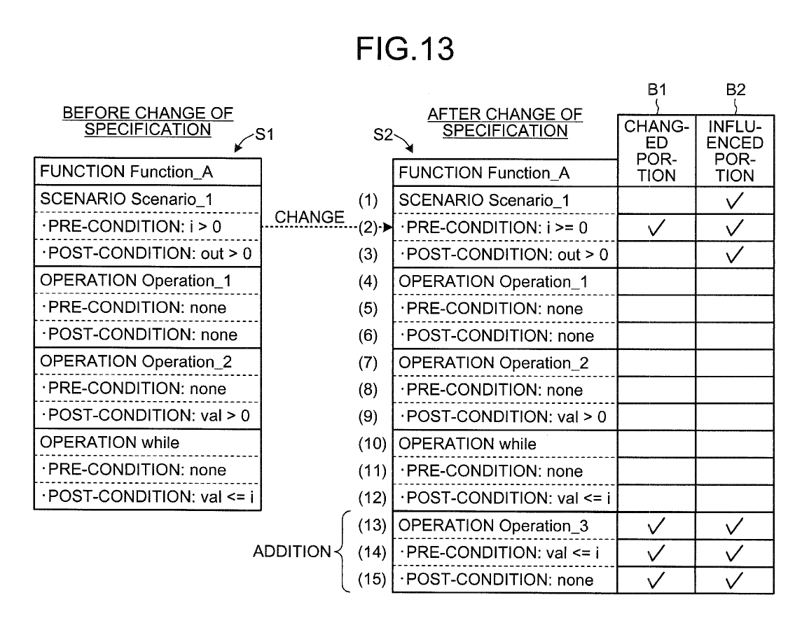

The approach of extracting the influenced ranges from the specification description S2 is not limited to the above. The overview of another approach of extracting the influenced ranges from the specification description S2 will be described with reference to FIG. 13. FIG. 13 is a diagram of the flow of extracting the description portions that are influenced by the change of the specification. In FIG. 13, the specification descriptions S1 and S2 before and after the change of the specification of the object to be verified are shown being simplified.

In this case, the description portions of the specification description S2 after the change of the specification are denoted by (1) to (15) for convenience. Putting checks in a changed portion box B1 and an influenced range box B2 means storing the identification result of the identifying unit 607 and the determination result of the determining unit 610 in the storage area such as the RAM 302, the magnetic disk 205, or the optical disc 207.

In this case, the pre-condition “i>0” of the scenario “Scenario_1” is changed to a pre-condition “i>=0” and a new operation “Operation_3” is added as the change of the specification of the object to be verified. Therefore, the identifying unit 607 identifies the description portions (2) and (13) to (15) as the changed portions in the specification description S2 (a check is put in the changed portion box B1).

The selecting unit 608 selects an arbitrary scenario from the specification description S2 (in this case, only the scenario “Scenario_1”). Whether a check is put in the changed portion box B1 of each of the description portions (2) and (3) concerning the pre-condition and the post-condition of the scenario “Scenario_1” is determined. More specifically, the seeking unit 609 seeks for the description portions (2) and (3) from the changed portions of the specification description S2. When each of the description portions (2) and (3) is found, it is determined that the check is put. In this case, a check is put for the description portion (2).

In this case, the determining unit 610 puts a check in the influenced range box B2 of each of the description portion (1) concerning the scenario “Scenario_1”, the description portion (2) concerning the pre-condition “i>=0”, and the description portion (3) concerning a post-condition “out>0”.

Thereafter, the selecting unit 608 selects arbitrary operations from the specification description S2 (in this case, “Operation_1”, “Operation_2”, “while”, and “Operation_3” are sequentially selected). It is determined whether a check is put in the changed portion box B1 of each of the description portions concerning the operations, the pre-conditions, and the post-conditions. In this case, checks are put for the description portions (13) to (15).

In this case, the determining unit 610 puts a check in the influenced range box B2 of each of the description portion (13) concerning the operation “Operation_3”, the description portion (14) concerning a pre-condition “val<=i”, and the description portion (15) concerning a post-condition “none”. As a result, the extracting unit 606 extracts the description portions (1) to (3) and (13) to (15) that are influenced by the change of the specification of the object to be verified, from the specification description S2.

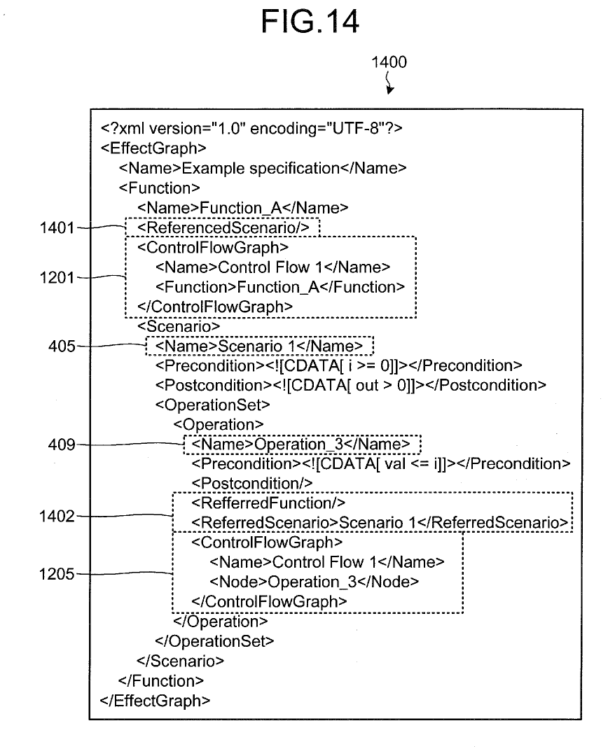

FIG. 14 is an explanatory diagram of a specific example of an influenced range description. In FIG. 14, an influenced range description 1400 is a set of description portions in the specification description S2 that are influenced by the change of the specification of the object to be verified.

The influenced range description 1400 is created by deleting the description portions that are not influenced by the change of the specification and the link information concerning these description portions, from the specification description S2 depicted in FIG. 12. Therefore, the influenced range description 1400 includes the description portions that are influenced by the change of the specification and the pieces of link information concerning these description portions. In this case, the pieces of link information 1201 and 1205 are included. The description portions denoted by numerals 1401 and 1402 are pieces of link information for tracing when the influenced ranges include other functions.

A process of searching for description portions to be changed in the implementation description from the description portions that are influenced by the change of the specification of the object to be verified will be described. The first searching unit 611 searches for the nodes that are correlated with the description portions extracted by the extracting unit 606 from the structure based on the correlation result of the second correlating unit 604. The second searching unit 612 searches for the description portions that are correlated with the nodes retrieved by the first searching unit 611 from the implementation description based on the correlation result of the first correlating unit 603.

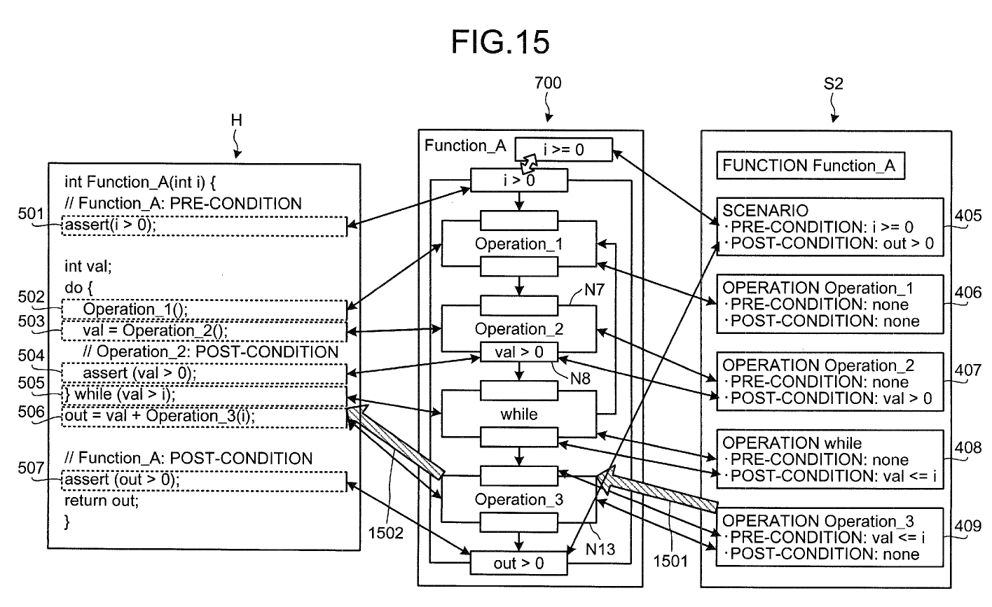

The flow of a process of searching for the description portions to be changed in the implementation description H from the description portions (the influenced range description 1400 depicted in FIG. 14) in the specification description S2 that are influenced by the change of the specification will be described. FIG. 15 is a diagram of the flow of searching for the description portions to be changed in the implementation description. The selecting unit 608 selects an arbitrary scenario or an arbitrary operation from the influenced range description 1400. The case where the operation “Operation_3” is selected is taken as an example and will be described.

The first searching unit 611 searches for the node N13 from the control flow graph 700 by referring to the link information 1205 of the operation “Operation_3”. The link information 1205 is the second correlation result that correlates the description portion 409 with the node N13. The node N13 corresponds to the description portion 1105 in the CFG description 900 depicted in FIG. 11. Therefore, the description portion 1105 is searched for from the CFG description 900 (an arrow 1501 in FIG. 15).

The second searching unit 612 searches for the description portion concerning the operation “Operation_3” from the implementation description H by referring to the link information 905 of the node N13. The link information 905 is the first correlation result that correlates the node N13 with the description portion 506. In this case, the description portion 506 in the 12th line in the implementation description H is searched for (an arrow 1502 in FIG. 15).

In this manner, a node correlated with an arbitrary operation in the specification description S2 can be searched for by referring to the second correlation result that correlates the description portion concerning the operations in the specification description S2 and the nodes in the control flow graph 700 (CFG description 900).

Similarly, as to pre-conditions and post-conditions (assertions), a node correlated with an arbitrary pre-condition or an arbitrary post-condition in the specification description S2 can be searched for by referring to the second correlation result. Even when the second correlation result that directly correlates a pre-condition or a post-condition with a node is not present, the node correlated with the pre-condition or the post-condition can be searched for using the following approach.

More specifically, the node may be searched for based on the link information that correlates the description portion concerning an operation in the specification description S2 with a node in the control flow graph 700. For example, when the node N8 that represents the post-condition “val>0” of the operation “Operation_2” is searched for, the node N7 is searched for based on the link information 1203 of the description portion 407 in the specification description S2.

The node N8 attached to the retrieved node N7 is searched for based on the node structure depicted in FIG. 7. In this manner, a node representing a pre-condition or a post-condition can be searched for utilizing the node structure when the link relation between the description portion concerning the operation in the specification description S2 and the node representing the operation in the control flow graph 700 is known.

The output unit 613 outputs the search result of the second searching unit 612 as the description portion in the implementation description to be changed due to the change of the specification of the object to be verified. More specifically, for example, the output unit 613 may output information that correlates the name of the file of the implementation description with the line number of the description portion to be changed in the implementation description. The output unit 613 may display the implementation description and may display in an emphasized form the description portion to be changed in the implementation description.

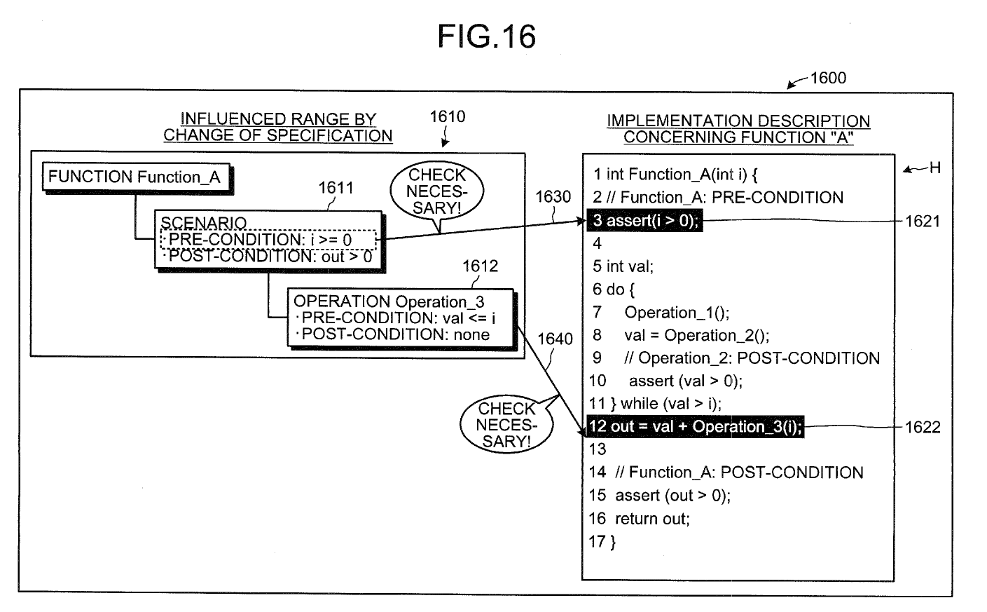

A specific exemplary output result (report information) by the output unit 613 will be described. FIG. 16 is an explanatory diagram of a specific example of report information. In FIG. 16, report information 1600 shows an influenced range 1610 in the specification description S2 that is influenced by the change of the specification of the object to be verified and the implementation description H after the change of the specification of the object to be verified.

In FIG. 16, arrows 1630 and 1640 respectively represent the correspondence relations between description portions 1611 and 1612 that are influenced by the change of the specification of the object to be verified, and assertion descriptions 1621 and 1622 in the implementation description H to be changed associated with the change of the specification of the object to be verified. The assertion descriptions 1621 and 1622 in the implementation description H are highlighted. The digits in the leftmost portion of the implementation description H are the line numbers in the implementation description H. According to the report information 1600, a verifying person may grasp the assertion descriptions 1621 and 1622 in the implementation description H to be changed due to the change of the specification of the object to be verified.

A computer automatically executes the procedure described as below by inputting into the verification assisting apparatus 100 the specification descriptions before and after the change of the specification of the object to be verified (for example, the specification descriptions S1 and S2) and the implementation description concerning the functions after the change of the specification (for example, the implementation description H).

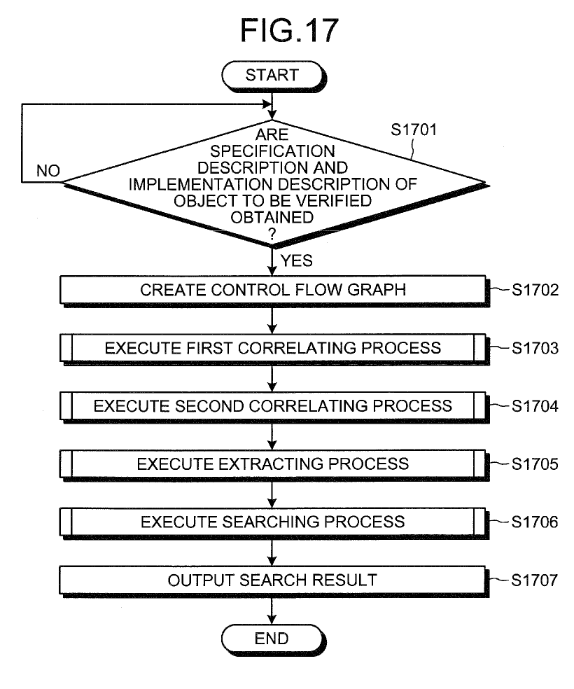

FIG. 17 is a flowchart of an exemplary verification assisting process. In the flowchart of FIG. 17, the obtaining unit 601 determines whether the specification descriptions before and after the change of the specification of the object to be verified and the implementation description concerning the functions after the change of the specification of the object to be verified are obtained (step S1701).

The flow does not advance until the specification descriptions before and after the change of the specification and the implementation description are obtained (step S1701: NO). When those descriptions are obtained (step S1701: YES), the creating unit 602 creates a control flow graph that shows the flow of the control during the implementation of the object to be verified based on the implementation description obtained (step S1702).

Thereafter, the first correlating unit 603 executes a first correlating process of correlating the implementation description with the control flow graph (step S1703). The second correlating unit 604 executes a second correlating process of correlating the specification description with the control flow graph (step S1704).

The extracting unit 606 executes an extracting process of extracting influenced ranges that are influenced by the change of the specification of the object to be verified from the specification description of the changed specification (step S1705). Thereafter, a searching process of searching for the description portions in the implementation description, to be changed due to the change of the specification of the object to be verified is executed (step S1706). The output unit 613 outputs a search result (step S1707) and the series of process steps according to the flowchart come to an end.

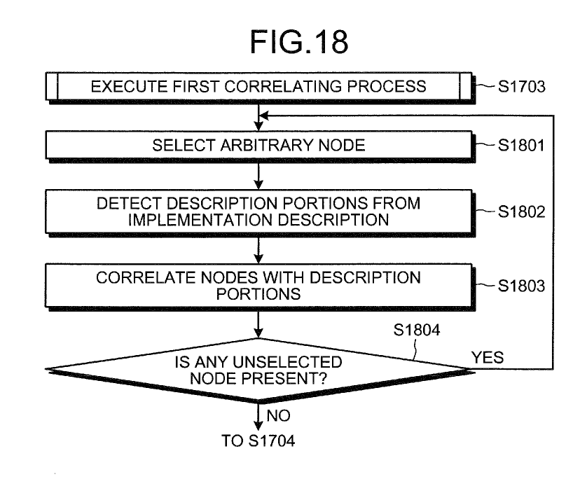

FIG. 18 is a flowchart of an exemplary procedure of the first correlating process. In the flowchart of FIG. 18, the selecting unit 608 selects an arbitrary node from the control flow graph created at step S1702 in FIG. 17 (step S1801).

Thereafter, the detecting unit 605 detects the description portion that is the creation origin of the selected node, from the implementation description obtained at step S1701 in FIG. 17 (step S1802). The first correlating unit 603 correlates the selected node with the detected description portion (step S1803).

It is determined whether any unselected node that is not selected from the control flow graph is present (step S1804). When an unselected node is present (step S1804: YES), the procedure returns to step S1801. On the other hand, when no unselected node is present (step S1804: NO), the procedure moves to step S1704 of FIG. 17.

Thereby, a description portion concerning an element (a scenario or an operation) or a restricting condition (a pre-condition or a post-condition) in the implementation description, and a node representing the description portion in the control flow graph can be correlated with each other.

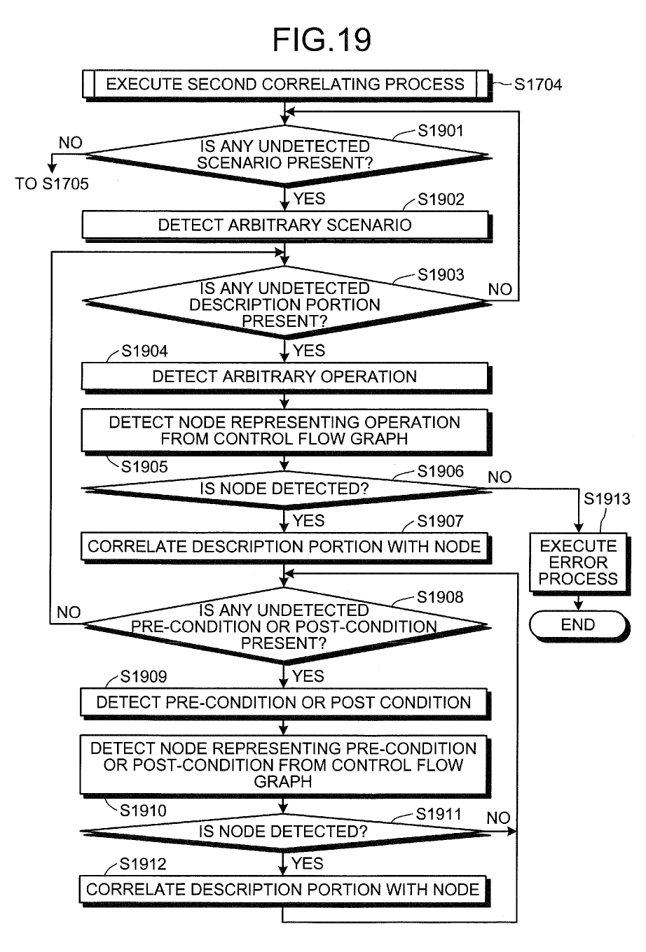

FIG. 19 is a flowchart of an exemplary procedure of the second correlating process. In the flowchart of FIG. 19, it is determined whether any description portion concerning an undetected scenario that is not detected from the specification description after the change of the specification obtained at step S1701 of FIG. 17 is present (step S1901).

When an undetected description portion is present (step S1901: YES), the detecting unit 605 detects the description portion concerning an arbitrary scenario from the specification description after the change of the specification (step S1902). Thereafter, it is determined whether any undetected description portion that concerns an operation that constitutes the above scenario and that is not detected from the specification description after the change of the specification is present (step S1903).

When an undetected description portion is present (step S1903: YES), the detecting unit 605 detects a description portion concerning an arbitrary operation that constitutes the above scenario from the specification description of the changed specification (step S1904). A node representing the above operation is detected from the control flow graph by referring to the detected description portion (step S1905).

When the node is detected (step S1906: YES), the second correlating unit 604 correlates the description portion concerning the operation with the node representing the operation (step S1907). Thereafter, it is determined whether any description portion concerning the pre-condition or the post-condition of the above operation that is not detected from the specification description of the changed specification is present (step S1908).

When the undetected description portion is present (step S1908: YES), the detecting unit 605 detects the description portion concerning the pre-condition or the post-condition of the above operation from the specification description of the changed specification (step S1909), and the detecting unit 605 detects the node representing the above pre-condition or post-condition from the control flow graph (step S1910).

When no node is detected (step S1911: NO), the procedure returns to step S1908. On the other hand, when the node is detected (step S1911: YES), the second correlating unit 604 correlates the description portion concerning the pre-condition or the post-condition and the node representing the pre-condition or the post-condition with each other (step S1912) and the procedure returns to step S1908.

When no undetected description portion is present at step S1908 (step S1908: NO), the procedure returns to step S1903. When no undetected description portion is present at step S1903 (step S1903: NO), the procedure returns to step S1901. When no undetected description portion is present at step S1901 (step S1901: NO), the procedure advances to step S1705 of FIG. 17.

When no node is detected at step S1906 (step S1906: NO), the output unit 613 executes an error process of reporting that mismatching of the name of the operation occurs between the specification description S2 and the implementation description H (step S1913) and the series of process steps come to an end.

Thereby, the description portions concerning the scenario and the operation, and the pre-condition and the post-condition of the scenario and the operation can be correlated with the nodes representing the description portions in the control flow graph.

In this case, the description portions concerning the pre-condition and the post-condition are correlated with the nodes representing the description portions in the control flow graph. However, the series of process steps (steps S1908 to S1912) for the above correlation may be omitted because, from a node representing a scenario or an operation in the control flow graph, the node representing the pre-condition or the post-condition of the scenario or the operation can be searched for utilizing the node structure.

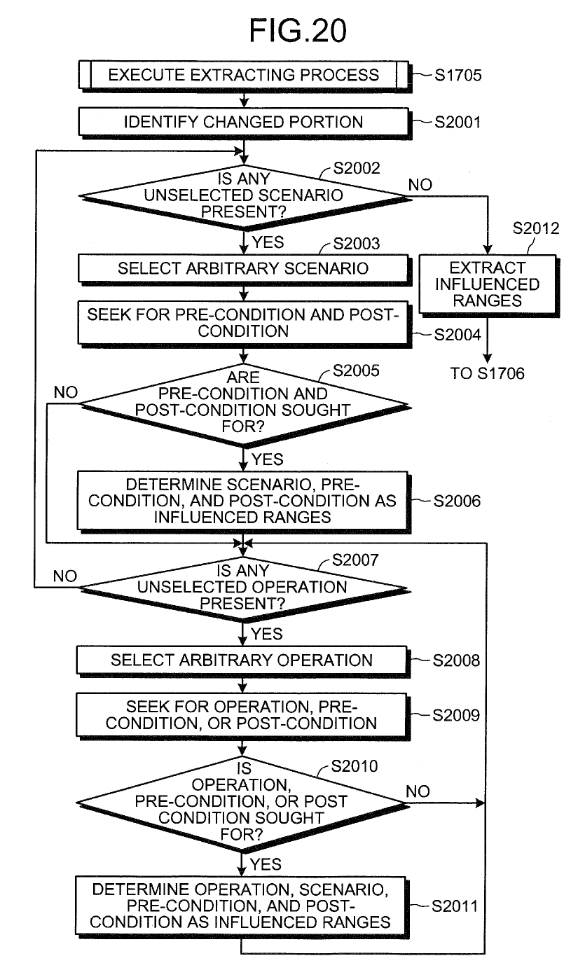

FIG. 20 is a flowchart of an exemplary procedure of the extracting process. In the flowchart of FIG. 20, the identifying unit 607 identifies the changed portions in the specification description after the change of the specification, associated with the change of the specification of the object to be verified, using the specification descriptions before and after the change of the specification obtained at step S1701 of FIG. 17 (step S2001).

Thereafter, it is determined whether any unselected scenario that is not selected from the specification description of the changed specification is present (step S2002). When the unselected scenario is present (step S2002: YES), the selecting unit 608 selects an arbitrary scenario (hereinafter, “selected scenario”) from the specification description of the changed specification (step S2003).

The seeking unit 609 seeks for the description portion concerning the pre-condition or the post-condition of the selected scenario from the changed portions identified at step S2001 (step S2004). When no description portion is found (step S2005: NO), the procedure advances to step S2007.

On the other hand, when the description portion is found (step S2005: YES), the determining unit 610 determines the description portion concerning the selected scenario and the description portions concerning the pre-condition and the post-condition of the selected scenario as the influenced ranges that are influenced by the change of the specification of the object to be verified (step S2006).

It is determined whether any unselected operation that is not selected from the specification description of the changed specification is present among operations that constitute the selected scenario (step S2007). When an unselected operation is present (step S2007: YES), the selecting unit 608 selects an arbitrary operation from the specification description of the changed specification (hereinafter, “selected operation”) (step S2008).

The seeking unit 609 seeks for the description portion concerning any one of the selected operation and the pre-condition and the post-condition of the selected operation, from the changed portions identified (step S2009). When the description portion is not found (step S2010: NO), the procedure returns to step S2007.

On the other hand, when the description portion is found (step S2010: YES), the determining unit 610 determines the description portions concerning the selected operation and the selected scenario and the description portions concerning the pre-conditions and the post-conditions of the selected operation and the selected scenario as the influenced ranges that are influenced by the change of the specification of the object to be verified (step S2011) and the procedure returns to step S2007.

When no unselected operation is present at step S2007 (step S2007: NO), the procedure returns to step S2002. When no unselected scenario is present at step S2002 (step S2002: NO) the extracting unit 606 extracts the influenced portions determined, from the specification description after the change of the specification (step S2012) and the procedure moves to step S1706 shown in FIG. 17.

Thereby, the influenced portions can be automatically extracted that are directly and indirectly influenced by the change of the specification (description portions that are the causes of occurrence of faults associated with the change of the specification) from the specification description after the change of the specification.

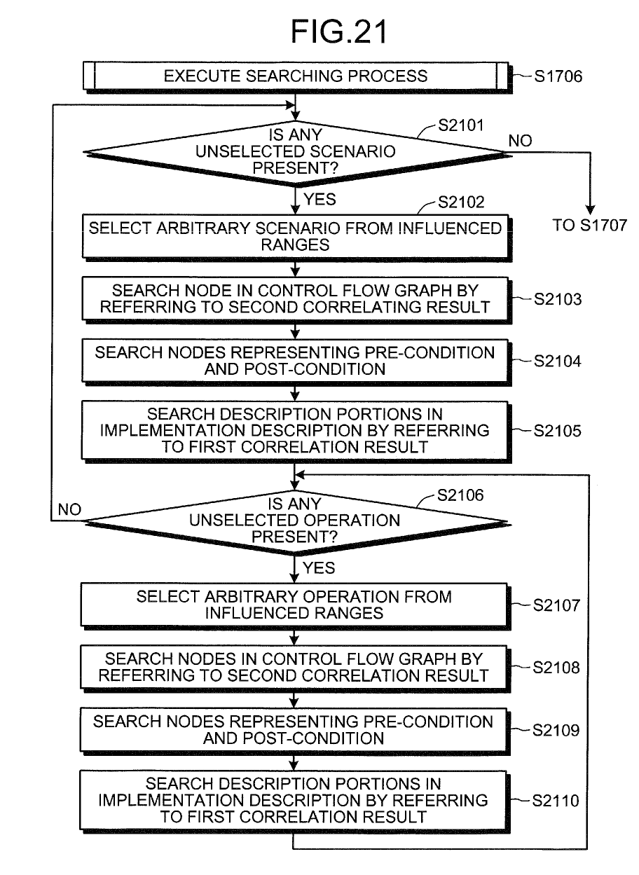

FIG. 21 is a flowchart of an exemplary procedure of the searching process. In the flowchart of FIG. 21, it is determined whether any unselected scenario that is not selected from the influenced ranges extracted at step S2012 of FIG. 20 is present (step S2101).

When an unselected scenario is present (step S2101: YES) the selecting unit 608 selects an arbitrary scenario (hereinafter, “selected scenario”) from the influenced ranges (step S2102). The first searching unit 611 searches for a node in the control flow graph that is correlated with the selected scenario by referring to the second correlation result of the second correlating process executed at step S1704 of FIG. 17 (step S2103). The first searching unit 611 searches for the nodes (hereinafter, “searched nodes”) representing the pre-condition and the post-condition, the searched nodes being attached to the retrieved node in the control flow graph (step S2104).

The second searching unit 612 searches for the description portions in the implementation description that are correlated with the searched nodes by referring to the first correlation result of the first correlating process executed at step S1703 of FIG. 17 (step S2105). When no description portions that are correlated with the searched nodes in the implementation description are present, the description portions are determined to be un-searched.

Thereafter, it is determined whether any unselected operation that is not selected from the influenced portions of the operations that constitute the selected scenario selected at step S2102 is present (step S2106). When an unselected operation is present (step S2106: YES), an arbitrary operation (hereinafter, “selected operation”) is selected from the influenced portions (step S2107).

Thereafter, the first searching unit 611 searches for a node in the control flow graph that is correlated with the selected operation by referring to the second correlation result of the second correlating process (step S2108). The first searching unit 611 searches for the searched nodes representing the pre-condition and the post-condition that are attached to the retrieved node (step S2109).

The second searching unit 612 searches for the description portions in the implementation description that are correlated with the searched nodes by referring to the first correlation result of the first correlating process (step S2110) and the procedure moves to step S2106. When no description portions that are correlated with the searched nodes in the implementation description are present at step S2110, the description portions are determined to be un-searched.

When no unselected operation is present at step S2106 (step S2106: NO), the procedure returns to step S2101. When no unselected scenario is present (step S2101: NO), the procedure moves to step S1707 of FIG. 17.

Thereby, the description portions in the implementation description to be changed associated with the change of the specification of the object to be verified (assertion descriptions) can be searched for.

As above, according to the embodiments, the description portions concerning the scenario, the operations, the pre-conditions, and the post-conditions in the specification description S2 after the change of the specification can be correlated with the description portions concerning the scenario, the operations, the pre-conditions, and the post-conditions in the implementation description H, through the control flow graph 700 (the CFG description 900) that is based on the implementation description H concerning the functions after the change of the specification of the object to be verified.

Using the correlation results (the first and the second correlation results), the description portions in the implementation description H may be searched for that are correlated with the description portions in the specification description S2 that are influenced by the change of the specification of the object to be verified. Thereby, the verifying person can grasp the description portions in the implementation description H to be changed associated with the change of the specification of the object to be verified by checking the search result (the report information 1600).

Especially, the assertion descriptions to be changed associated with the change of the specification of the object to be verified can be efficiently and collectively grasped from the tremendous number (for example, several thousand to several hundred thousand) of assertion descriptions dispersed in the implementation description H.

Thereby, the conventional troublesome work becomes unnecessary such as comparing the specification descriptions S1 and S2 before and after the change of the specification and the implementation H with each other and manually checking the assertions to be changed every time the specification is changed. Therefore, reduction of the work load on the verification work and reduction of time for the work can be achieved. Furthermore, compared to the conventional manual check, the assertion descriptions to be changed can be collectively grasped. Therefore, improvement of the verification quality can be facilitated.

The verification assisting method in the present embodiments can be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program can be distributed through a network such as the Internet.

The verification assisting apparatus 100 described in the present embodiments can be realized by an application specific integrated circuit (ASIC) such as a standard cell or a structured ASIC, or a programmable logic device (PLD) such as a field-programmable gate array (FPGA). Specifically, for example, functional units (the obtaining unit 601 to the output unit 613) of the verification assisting apparatus 100 are defined in hardware description language (HDL), which is logically synthesized and applied to the ASIC, the PLD, etc., thereby enabling manufacture of the verification assisting apparatus 100.

As set forth above, according to the embodiments, assertions can be identified efficiently and exhaustively that should be changed when the specification of an object changes. As a result, confirmation between the implementation and the specification can be efficiently performed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A computer-readable recording medium storing a program for assisting a matching check between a specification and implementation of an object to be verified, the program causing a computer to perform:
obtaining a specification description that includes elements executed to realize functions of the object to be verified and restricting conditions of the elements to be satisfied to realize the functions, and an implementation description concerning the functions;
creating a graph structure that includes, as nodes, the elements and the restricting conditions on the elements, based on the implementation description;
first correlating nodes in the graph structure with description portions in the implementation description concerning the elements or the restricting conditions that the nodes represent;
second correlating a node in the graph structure with a description portion in the specification description concerning an element or a restricting condition that the node represents, by detecting the node that represents the element or the restricting condition in the structure using a description concerning the element or the restricting condition in the specification description; and
outputting the correlation results correlated at the first and the second correlating.

2. The computer-readable recording medium of claim 1, wherein the program further causing the computer to perform:
extracting description portions that are influenced by the change of the specification of the object to be verified from the specification description;
first searching for the nodes that are correlated with the description portions from the graph structure based on the correlation result correlated by the second correlating; and
second searching for the description portions that are correlated with the nodes searched at the first searching from the implementation description based on the correlation result correlated at the first correlating, and wherein
at the outputting, the search result of the second searching is output.

3. The computer-readable recording medium of claim 2, wherein the program further causing the computer to perform:
identifying changed portions in the specification description after the change of the specification associated with the change of the specification of the object to be verified, using the specification descriptions before and after the change of the specification of the object to be verified;
selecting an arbitrary element from the changed portions identified at the identifying;
seeking for the restricting conditions of the element selected at the selecting from the specification description after the change of the specification; and
determining the description portions concerning the restricting conditions sought at the seeking as the description portions that are influenced by the change of the specification of the object to be verified, and wherein
at the extracting, the changed portions and the description portions determined at the determining are extracted from the specification description after the change of the specification.

4. The computer-readable recording medium of claim 3, wherein
at the seeking, elements that are influenced by the change of the specification are sought for from the specification description after the change of the specification by sequentially tracing the elements that are the transition origins, using the element selected at the selecting as a starting point, based on the transition relation between elements that is based on the specification description after the change of the specification, and wherein
at the determining, the description portion concerning the element and the description portions concerning the restricting conditions of the element sought for at the seeking are determined to be the description portions that are influenced by the change of the specification of the object to be verified.

5. The computer-readable recording medium of claim 3, wherein
at the selecting, an arbitrary restricting condition is selected from the specification description after the change of the specification, wherein
at the seeking, an element for which the restricting condition selected at the selecting is defined is sought for from the specification description after the change of the specification, and wherein
at the determining, the description portion concerning the element sought for at the seeking is determined to be the description portion that is influenced by the change of the specification of the object to be verified.

6. The computer-readable recording medium of claim 1, wherein
the element is a scenario that is included in the function or an operation that is included in the scenario, wherein
the restricting condition is at least any one of a pre-condition, a post-condition, and an invariant condition of the scenario or the operation, and wherein
at the creating, a control flow graph that shows the flow of the control during the implementation of the object to be verified is created by forming a directed graph using the scenario, the operation, the pre-condition, the post-condition, and the invariant condition described in the implementation description.

7. A verification assisting apparatus for assisting a matching check between a specification and implementation of an object to be verified, comprising:
an obtaining unit configured to obtain a specification description that includes elements executed to realize functions of the object and restricting conditions of the elements to be satisfied to realize the functions, and an implementation description concerning the functions;
a creating unit configured to create a graph structure that includes, as nodes, the elements and the restricting conditions, based on the implementation description;
a first correlating unit configured to correlate nodes in the graph structure with description portions in the implementation description concerning the elements or the restricting conditions that the nodes represent;
a second correlating unit configured to correlate a node in the graph structure with a description portion in the specification description concerning an element or a restricting condition that the node represents, by detecting the node that represents the element or the restricting condition in the structure using a description concerning the element or the restricting condition in the specification description; and
an outputting unit configured to output the correlation results correlated by the first and the second correlating unit.

8. A verification assisting method for assisting a matching check between a specification and implementation of an object to be verified, comprising:
obtaining a specification description that includes elements executed to realize functions of the object to be verified and restricting conditions of the elements to be satisfied to realize the functions, and an implementation description concerning the functions;
creating a graph structure that includes, as nodes, the elements and the restricting conditions on the elements, based on the implementation description;
first correlating nodes in the graph structure with description portions in the implementation description concerning the elements or the restricting conditions that the nodes represent;
second correlating a node in the graph structure with a description portion in the specification description concerning an element or a restricting condition that the node represents, by detecting the node that represents the element or the restricting condition in the structure using a description concerning the element or the restricting condition in the specification description; and
outputting the correlation results correlated by the first and the second correlating.
